(19) United States
(12) Patent Application Publication
(10) Pub. No.: US 2008/0103708 A1
(43) Pub. Date: May 1, 2008

(54) Leakage power estimation

(75) Inventors: Takeshi Inoue, Austin, TX (US); James D. Warnock, Somers, NY (US); Douglas H. Bradley, Austin, TX (US); Noah Zamdmer, Tarrytown, NY (US); Dennis Cox, Rochester, MN (US); Edward Nowak, Essex Junction, VT (US)

Correspondence Address: KAPLAN GILMAN GIBSON & DERNIER L.L.P., 900 ROUTE 9 NORTH, WOODBRIDGE, NJ, 07095, US

(73) Assignees: Sony Computer Entertainment Inc., Tokyo (JP); International Business Machines Corporation, Armonk, NY (US)

(21) Appl. No.: 11/549,165

(22) Filed: Oct. 13, 2006

(51) Int. Cl. G06F 19/00; G06F 17/40

(52) U.S. Cl. 702/60; 702/1; 702/127; 702/57; 702/79; 702/187; 702/189; 702/108; 702/117

(57) ABSTRACT

Methods and apparatus provide for estimating leakage power as a function of delay times. Delay times and leakage power values may be measured for a test circuit of a given circuit design. A statistical sampling of the measurements may be obtained for the test circuit. The delay data and leakage power data may be correlated to express and estimate leakage power as a function of delay distribution. The test circuit may include a proposed circuit that is simulated, and the method and apparatus also may provide for: creating a schematic design of the test circuit, having, for example, defined poly gate lengths, on-chip devices, and power sources; incorporating a delay chain into the schematic design to get delay distribution data; and utilizing the schematic design, wherein the utilitzation may be a simulation.

### BACKGROUND

The present invention relates to methods and apparatus for estimating leakage power in single and multi-processor systems. In particular, leakage power may be estimated using statistical samplings of delay time data.

In recent years, there has been an insatiable desire for faster computer processing data throughputs because cutting-edge computer applications involve real-time, multimedia functionality. Graphics applications are among those that place the highest demands on a processing system because they require such vast numbers of data accesses, data computations, and data manipulations in relatively short periods of time to achieve desirable visual results. These applications require extremely fast processing speeds, such as many thousands of megabits of data per second. While some processing systems employ a single processor to achieve fast processing speeds, others are implemented utilizing multi-processor architectures. In multi-processor systems, a plurality of sub-processors can operate in parallel (or at least in concert) to achieve desired processing results.

For example, a multi-processor system may include a plurality of processors all sharing a common system memory, where each processor also has a local memory in which to execute instructions. The multi-processor system may also include an external interface, for example, to connect with other processing systems and/or other external devices to permit the sharing of data and resources. While this can achieve significant benefits in functionality, processing power, etc., the design of such systems may aggravate the problem of power leakage in some circumstances. The amount of power leaked is known as leakage power.

As the channel lengths in complementary metal-oxide semiconductor (CMOS) technology become shorter, leakage power tends to increase on the chip. Subthreshold leakage is the current that flows from the drain to the source of a MOSFET when the transistor is supposed to be in the off-state. As transistors have been scaled down, subthreshold leakage has grown from being very small to composing nearly 50% of total power consumption. The reason for this is that the supply voltage has continually scaled down to reduce the dynamic power consumption of integrated circuits, i.e., the power that is consumed when the transistor is switching from an on-state to an off-state, which depends on the square of the supply voltage. As the supply voltage is scaled down, to maintain performance, the threshold voltage has to be reduced in the same proportion. As threshold voltages are reduced, subthreshold leakage rises exponentially.

Accurate estimations of the leakage power of a large-scale integrated circuit are desired so that system designers and chip designers can factor the estimated leakage power into their designs to make their design margins as small as possible and thereby reduce costs. Designs which try to optimize their fabrication processes for minimum power dissipation during operation have been lowering Vₜₕ so that leakage power begins to approximate switching power. As Vₜₕ is lowered, leakage power begins to approximate switching power, causing devices to dissipate considerable power even when not switching. Leakage power reduction, such as using new material and system design, is critical to sustaining scaling of CMOS.

Considering that the voltage ID is determined as a function of chip performance to optimize total power, leakage power has been estimated as a function of performance, even though each chip has its own applied voltage. Inasmuch as performance and circuit size have been correlated closely, previous estimation techniques have estimated leakage power as a function of poly gate length (Lpoly). Leakage power estimation as a function of Lpoly may be easy to do, but it is not very accurate, inasmuch as chip performance is affected by factors other than Lpoly. Lpoly values correlate with chip performance, but an Lpoly distribution curve for leakage power, however, may be relatively narrow compared to a chip performance distribution curve, because of the effects of other factors affecting chip performance.

It would therefore be desirable to estimate leakage power more accurately based on a wider data distribution curve.

### SUMMARY OF THE INVENTION

In accordance with the present invention, delay times may be used as a measure of performance in estimating leakage power. Although delay times are an often-used measure of performance, where the delay is not a nominal value, delay times have not been used previously to estimate leakage power. Insofar as chip performance is affected not only by Lpoly but also by threshold-gate-to-source voltage (Vth), tox, etc., the invention includes more accurately estimating leakage power as a function of delays resulting from Lpoly as well as from the other performance-affecting factors, whose effects can be simulated using the Monte Carlo method, i.e., statistical sampling.

In accordance with one or more features described herein, methods and apparatus provide for estimating leakage power as a function of delay times. Delay times and leakage power values may be measured for a test circuit of a given circuit design. A statistical sampling of the measurements may be obtained for the test circuit. The delay data and leakage power data may be correlated to express and estimate leakage power as a function of delay distribution. The leakage power estimation may include a generalized expression of measured leakage power data as a function of measured delay data.

In accordance with one or more further inventive aspects, a method of estimating leakage power of a test circuit, such as a proposed circuit, may include some or all of the following actions: creating a schematic design of the test circuit, having, for example, defined poly gate lengths, on-chip devices, and power sources; incorporating a delay chain into the schematic design to get delay distribution data; utilizing the schematic design, wherein the utilitzation is a simulation; measuring leakage power and delay for the design utilization; obtaining a statistical sampling of distributions of leakage power data and delay data for the design utilization; correlating the leakage power data distribution and the delay data distribution; and deriving a leakage power estimation as a function of delay data distribution.

In accordance with one or more further inventive aspects, an apparatus includes a leakage power estimation tool. The leakage power estimation tool may include a leakage power measurement device or means, a delay time measurement device or means, and a processing system or means. The leakage power measurement device or means may measure a statistical sampling of a distribution of the leakage power of a test circuit. The delay time measurement device or means may measure a statistical sampling of a distribution of the delay times of the test circuit. The processing system or means may correlate the leakage power measurements and the delay time measurements to derive an equation with which to estimate leakage power as a function of delay time.

In accordance with one or more further inventive aspects, a computer-readable storage medium may contain computer-executable instructions capable of causing a processing system to perform actions of a method of estimating leakage power of a test circuit. The actions may include deriving a leakage power estimation as a function of delay distribution. The actions also may include: measuring leakage power and delay for a utilization of a schematic design of the test circuit; obtaining a statistical sampling of a leakage power data distribution and a delay data distribution for the utilization; and correlating the leakage power data distribution and the delay data distribution. Further actions may include: creating the schematic design of the proposed circuit having, for example, defined poly gate lengths, on-chip devices, and power sources; incorporating a delay chain into the schematic design to get delay distribution data; and utilizing the schematic design, wherein the utilitzation is a simulation.

A preferred implementation of the present invention may utilize a microprocessor architecture known as Cell Broadband Engine Architecture, commonly abbreviated “CBEA,” “Cell BE,” or simply “Cell.” The CBEA combines a light-weight general-purpose POWER-architecture core of modest performance with multiple GPU-like streamlined co-processing elements into a coordinated whole, with a sophisticated memory coherence architecture. POWER is a backronym for “Performance Optimization With Enhanced RISC” and refers to a RISC instruction set architecture, as well as a series of microprocessors that implements the instruction set architecture.

The CBEA greatly accelerates multimedia and vector processing applications, as well as many other forms of dedicated computation. The CBEA emphasizes efficiency over watts, bandwidth over latency, and peak computational throughput over simplicity of program code.

The CBEA can be split into four components: external input and ouput structures; the main processor called the POWER Processing Element (“PPE”) (a two-way simultaneous multithreaded POWER 970 architecture compliant core); eight fully functional co-processors called the Synergistic Processing Elements (“SPEs”); and a specialized high bandwidth circular data bus connecting the PPE, input/output elements and the SPEs, called the Element Interconnect Bus (“EIB”). To achieve the high performance needed for mathematically intensive tasks such as decoding/encoding MPEG streams, generating or transforming three dimensional data, or undertaking Fourier analysis of data, the CBEA marries the SPEs and the PPE via the EIB to give the SPEs and the PPE access to main memory or other external data storage.

Within the Cell Broadband Engine Architecture, a Broadband Engine (BE) may include one or more PPEs. The PPE is capable of running a conventional operating system and has control over the SPEs, allowing it to start, stop, interrupt and schedule processes running on the SPEs. To this end, the PPE has additional instructions relating to control of the SPEs. Despite having Turing complete architectures, the SPEs are not fully autonomous and require the PPE to initiate them before they can do any useful work. Most of the “horsepower” of the system comes from the synergistic processing elements, SPEs.

Each SPE is composed of a “Streaming Processing Unit” (“SPU”), and a Synergistic Memory Flow (SMF) controller unit. The SMF may have a digital memory access (DMA), a memory management unit (MMU), and a bus interface. An SPE is a RISC processor with 128-bit single-instruction, multiple-data (SIMD) organization for single and double precision instructions. With the current generation of the CBEA, each SPE contains a 256 KiB instruction and data local memory area (called “local store”) which is visible to the PPE and can be addressed directly by software. Each of these SPE can support up to 4 GB of local store memory, as static random access memory (SRAM). The local store does not operate like a conventional CPU cache since it is neither transparent to software nor does it contain hardware structures that predict what data to load.

An exemplary CBEA multiprocessing system may have eight valid SPEs in a common IC, giving it much flexibility in product implementation. For instance, as the CBEA is manufactured, one of the SPEs may become faulty and, therefore, the overall performance of the IC may be reduced. Instead of discarding the IC, the reduced performance multiprocessing system may be used in an application (e.g., a product) that does not require a full complement of SPEs. For example, a high performance video game product may require a full complement of SPEs; however, a digital television (DTV) might not require a full complement of SPEs. Depending on the complexity of the application in which the multiprocessing system is to be used, a lesser number of SPEs may be employed by disabling the faulty SPE and using the resulting multiprocessing system in a less demanding environment (such as a DTV).

Other aspects, features, advantages, etc. will become apparent to one skilled in the art when the description of the invention herein is taken in conjunction with the accompanying drawings.

### BRIEF DESCRIPTION OF THE DRAWINGS

For the purposes of illustrating the various aspects of the invention, there are shown in the drawings, wherein like numerals indicate like elements, forms that are presently preferred, it being understood, however, that the invention is not limited to the precise arrangements and instrumentalities shown, but instead only by the claims.

FIG. 1 is a block diagram illustrating the structure of a multiprocessing system having two or more sub-processors in accordance with one or more aspects of the present invention.

FIG. 2 is a block diagram illustrating the structure of a leakage power estimation tool in accordance with one or more aspects of the present invention.

FIG. 3 is a flow diagram illustrating actions that may be carried out in an exemplary process in accordance with one or more aspects of the present invention

FIGS. 4A and 4B graphically depict leakage power as a function of delay time.

FIG. 5 is a diagram illustrating a broadband engine (BE) that may be used to implement one or more further aspects of the present invention.

FIG. 6 is a diagram illustrating the structure of an exemplary synergistic processing element (SPE) of the system of FIG. 5 that may be adapted in accordance with one or more further aspects of the present invention.

FIG. 7 is a diagram illustrating the structure of an exemplary POWER processing element (PPE) of the system of FIG. 5 that may be adapted in accordance with one or more further aspects of the present invention.

### DETAILED DESCRIPTION OF THE PRESENT INVENTION

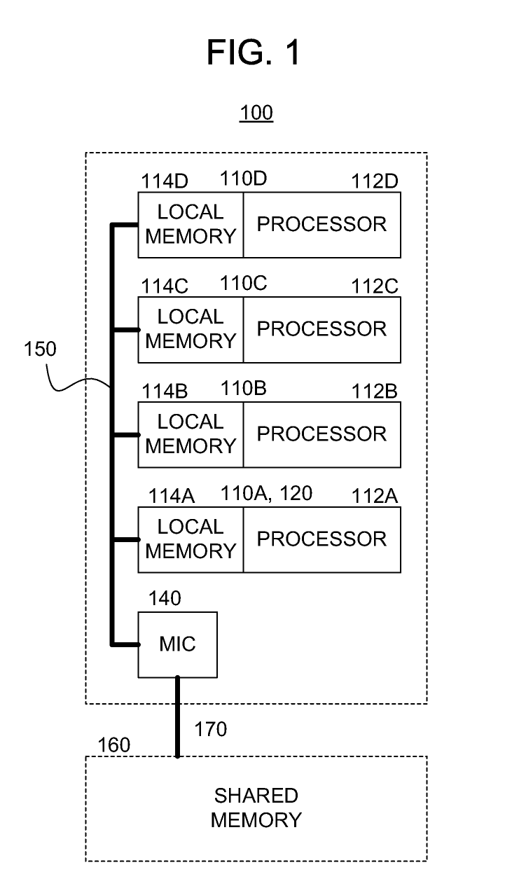

Referring to FIG. 1, a processing system 100 suitable for implementing one or more features of the present invention is shown. For the purposes of brevity and clarity, the block diagram of FIG. 1 will be referred to and described herein as illustrating an apparatus, it being understood, however, that the description may readily be applied to various aspects of a method with equal force.

The processing system 100 includes a plurality of processors 110A, 110B, 110C, and 110D, it being understood that any number of processors may be employed without departing from the spirit and scope of the invention. The processing system 100 also preferably includes a memory interface circuit 140 and a shared memory 160. At least the processors 110A, 110B, 110C, 110D, and the memory interface circuit 140 are preferably coupled to one another over a bus system 150 that is operable to transfer data to and from each component in accordance with suitable protocols.

Each of the processors 110A, 110B, 110C, 110D may be of similar construction or of differing construction. The processors may be implemented utilizing any of the known technologies that are capable of requesting data from the shared (or system) memory 160, and manipulating the data to achieve a desirable result. For example, the processors 110A, 110B, 110C, 110D may be implemented using any of the known microprocessors that are capable of executing software and/or firmware, including standard microprocessors, distributed microprocessors, etc. By way of example, one or more of the processors 110A, 110B, 110C, 110D may be a graphics processor that is capable of requesting and manipulating data, such as pixel data, including gray scale information, color information, texture data, polygonal information, video frame information, etc.

In an alternative embodiment, one or more of the processors 110A, 110B, 110C, 110D of the system 100 may take on the role as a main (or managing) processor 120. The system 100 may include a main processor 120, e.g. processor 110A, operatively coupled to the other processors 110B, 110C, 110D and capable of being coupled to the shared memory 160 over the bus system 150. The main processor 120 may schedule and orchestrate the processing of data by the other processors 110B, 110C, 110D. Unlike the other processors 110B, 110C, 110D, however, the main processor 120 may be coupled to a hardware cache memory, which is operable cache data obtained from at least one of the shared memory 160 and one or more of the local memories of the processors 110A, 110B, 110C, 110D. The main processor 120 may provide data access requests to copy data (which may include program data) from the system memory 160 over the bus system 150 into the cache memory for program execution and data manipulation utilizing any of the known techniques, such as DMA techniques.

The memory interface circuit 140 is preferably operable to facilitate data transfers between the processors 110A, 110B, 110C, 110D and the shared memory 160 such that the processors 110 may execute application programs and the like. By way of example, the memory interface circuit 140 may provide one or two high-bandwidth channels 170 into the shared memory 160 and may be adapted to be a slave to the bus system 150. Any of the known memory interface technologies may be employed to implement the memory interface circuit 140.

The system memory 160 is preferably a dynamic random access memory (DRAM) coupled to the processors 110A, 110B, 110C, 110D through the memory interface circuit 140. Although the system memory 160 is preferably a DRAM, the memory 160 may be implemented using other means, e.g., a static random access memory (SRAM), a magnetic random access memory (MRAM), an optical memory, a holographic memory, etc.

Turning again to the processors, each processor 110A, 110B, 110C, 110D preferably includes a processor core 112 (e.g., 112A-D) and a local memory 114 (e.g., 114A-D) in which to execute programs. These components may be integrally disposed on a common semi-conductor substrate or may be separately disposed as may be desired by a designer. The processor core 112 is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the processor core 112 may include an instruction buffer, instruction decode circuitry, dependency check circuitry, instruction issue circuitry, and execution stages.

The local memory 114 is coupled to the processor core 112 via a bus and is preferably located on the same chip (same semiconductor substrate) as the processor core 112. The local memory 114 is preferably not a traditional hardware cache memory in that there are no on-chip or off-chip hardware cache circuits, cache registers, cache memory controllers, etc. to implement a hardware cache memory function. As on chip space is often limited, the size of the local memory 114 may be much smaller than the shared memory 160.

The processors 112 preferably provide data access requests to copy data (which may include program data) from the system memory 160 over the bus system 150 into their respective local memories 114 for program execution and data manipulation. The mechanism for facilitating data access may be implemented utilizing any of the known techniques, for example the direct memory access (DMA) technique.

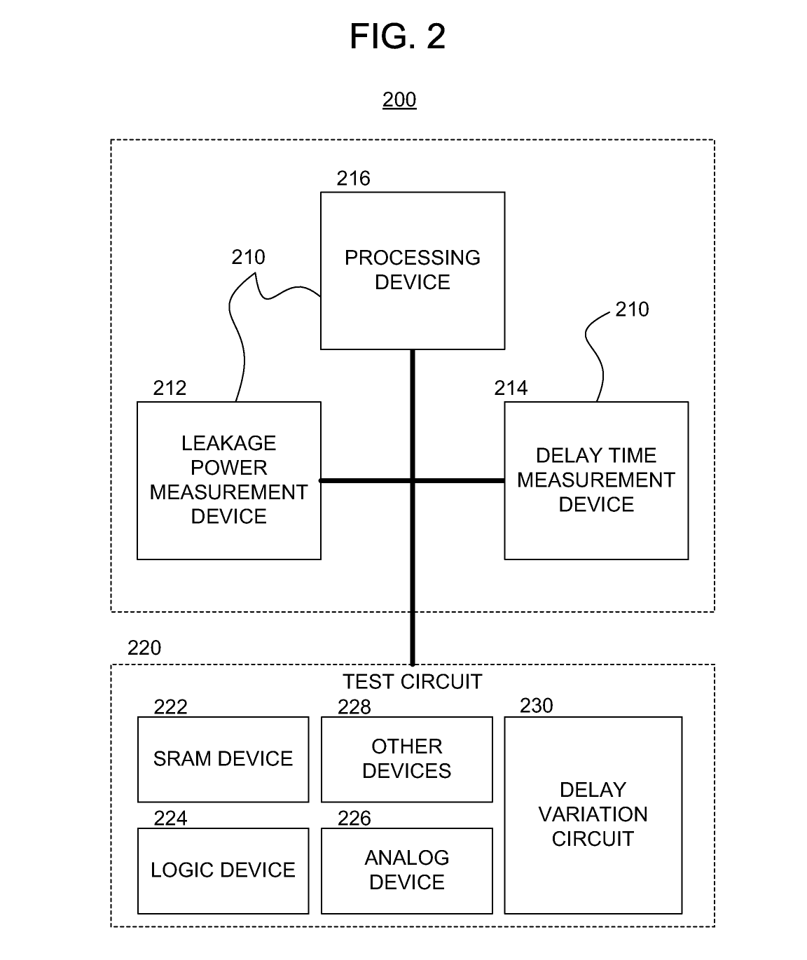

Referring to FIG. 2, a block diagram illustrates the structure of a leakage power estimation tool 200 in accordance with one or more aspects of the present invention. The leakage power estimation tool 200 may include three main components 210: a leakage power measurement device or means 212, a delay time measurement device or means 214, and a processing device or means 216. Leakage power measurement device or means 212 and delay time measurement device or means 214 may be coupled to processing device or means 216. Although depicted as an apparatus, the tool 200 may comprise any feasible combination of hardware and software that performs the necessary measurement and processing functions. For example, tool 200 may comprise an existing diagnostic device that is modified to perform to a method in accordance with the present invention.

Leakage power estimation tool 200 may measure instances of the delay data and leakage power data of a test circuit 220. The test circuit 220 may have, for instance, the structure of processing system 100 shown in FIG. 1 and/or similar constructions. As shown in FIG. 2, test circuit 220 may include one or more of: an SRAM device 222, a logic device 224, an analog device 226 and other devices 228. Depending on the implementation, test circuit 220 also may include a delay variation circuit 230, and the delay variation circuit 230 also may function as a delay variation measurement circuit to assist or act as the delay time measurement device or means 214. Test circuit 220 may be coupled to leakage power measurement device or means 212 and delay time measurement device or means 214. Processing device 216 may utilize the test circuit 220 to perform various test operations. During the performance of the test operations, leakage power measurement device 212 and delay time measurement device 214 may measure, respectively, leakage power values and delay times associated with the test operations. Processing device 216 may obtain and correlate a statistical sampling of the leakage power values and delay times measured during performance of the test operations. In view of the correlation of the distribution of measured delay data and the distribution of measured leakage power data, the processing device 216 may derive an estimation of leakage power by expressing generally the measured leakage power data as a function of the measured delay data. Using this generalized expression, the processing device 216 may estimate leakage power as a function of delay times.

In accordance with other embodiments of the present invention, leakage power estimation tool 200 alternatively may make measurements of simulated delays and simulated leakage power of a test circuit 220, where the test circuit 220 is a simulation, such as of a proposed circuit. The test circuit 220 may be described in a schematic design that, for example, would serve as a blueprint for manufacturing the proposed circuit. The processing device 216 may function as a circuit simulator, whereby the functioning of the test circuit 220 in performance of the test operations would be simulated. Simulation of test circuit 220 and its functioning would be accomplished using known techniques. The schematic design may incorporate a delay chain into the schematic design to get a delay data distribution. The delay variation circuit may enable the delay chain, and the delay variation circuit also may function as a delay variation measurement circuit to assist or act as the delay measurement device or means 214.

Processing device 216 may have a single processor construction or a multi-processor structure similar, for instance, to that of processing system 100 shown in FIG. 1. To achieve the interconnection between tool components 210, processing system 100 may include an external interface circuit (not shown) that is adapted to facilitate data transfers between, for example, the system 100 and one or more of the other components 210 over a communications channel, such as a bus extension. Preferably, the external interface circuit is adapted to exchange non-coherent traffic with an external device and/or operate coherently by extending the bus system 150 to the other processing systems.

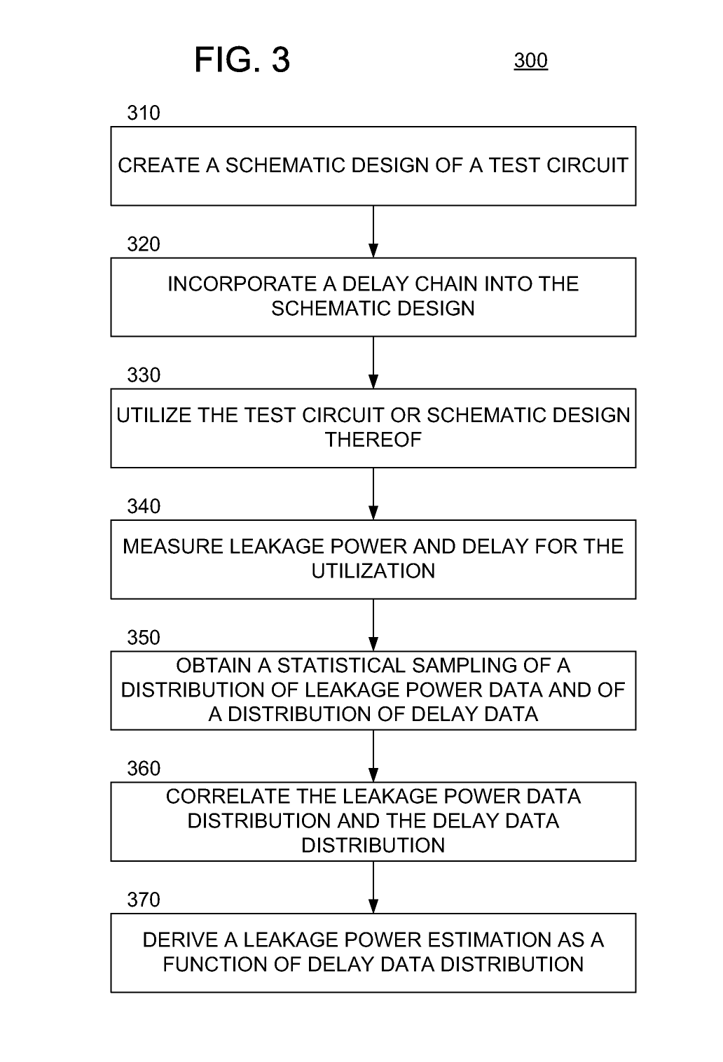

Referring to FIG. 3, a flow diagram illustrates actions that may be carried out in an exemplary process in accordance with one or more aspects of the present invention. An exemplary process 300 of estimating leakage power as a function of delay times may include one or more of the following actions, depending on the circumstances. For instance, a circuit designer may wish to estimate leakage power distributions for a test circuit 220 based on a prototype thereof, or based only on a schematic design of a proposed circuit.

In the case where the test circuit 220 is a proposed circuit, a process 300 may include creating a schematic design of the test circuit 220 (action 310). The schematic design may include, for example, defined poly gate lengths, on-chip devices, and power sources, so that the schematic design accurately describes the proposed circuit. To facilitate data collection, a delay chain may be incorporated (action 320) into the schematic design to obtain a distribution of delay data. The schematic design would then be utilized (action 330), wherein the utilitzation would be a simulation in the case of a proposed circuit.

Utilizing either a prototype or schematic design of the test circuit, a leakage power estimation tool 200, for instance, may measure leakage power and delay for the utilization (action 340). The utilization of test circuit 220 or of the schematic design thereof may include the performance various test operations, during which leakage power and delay associated with the test operations are measured. The measurement of leakage power and delay yields leakage power values and delay times, from which the tool 200 may obtain a statistical sampling of distributions of leakage power data and delay data for the utilization (action 350) The process 300 then involves correlating the leakage power data distribution and the delay data distribution (action 360). The delay data and leakage power data may be correlated to create a generalized expression of measured leakage power data as a function of measured delay data. From this generalized expression, the tool 200 may derive a leakage power estimation as a function of delay data distribution (action 370), with which to estimate leakage power as a function of the delay data distribution.

The process 300 may be abbreviated, for example, if one or more of the earlier actions is obviated, such as where the leakage power data and delay data are already available for a given test circuit 220. Where the leakage power data and the delay data are already available, statistical samples of their distributions may be obtained and correlated, the result of which may express leakage power as a function of delay data, forming the basis of the leakage power estimation.

The tool 200 and the process 300 may implement as well as test circuits having designs similar to processing systems 100. More accurate estimation of leakage power in the context of such complex multi-processor systems 100 is even more valuable than in the context of simpler systems due to the greater variability introduced by the multiple processors. In particular, estimating leakage power based on schematic designs may help reduce costs associated with preliminary prototypes that may prove to be unnecessary.

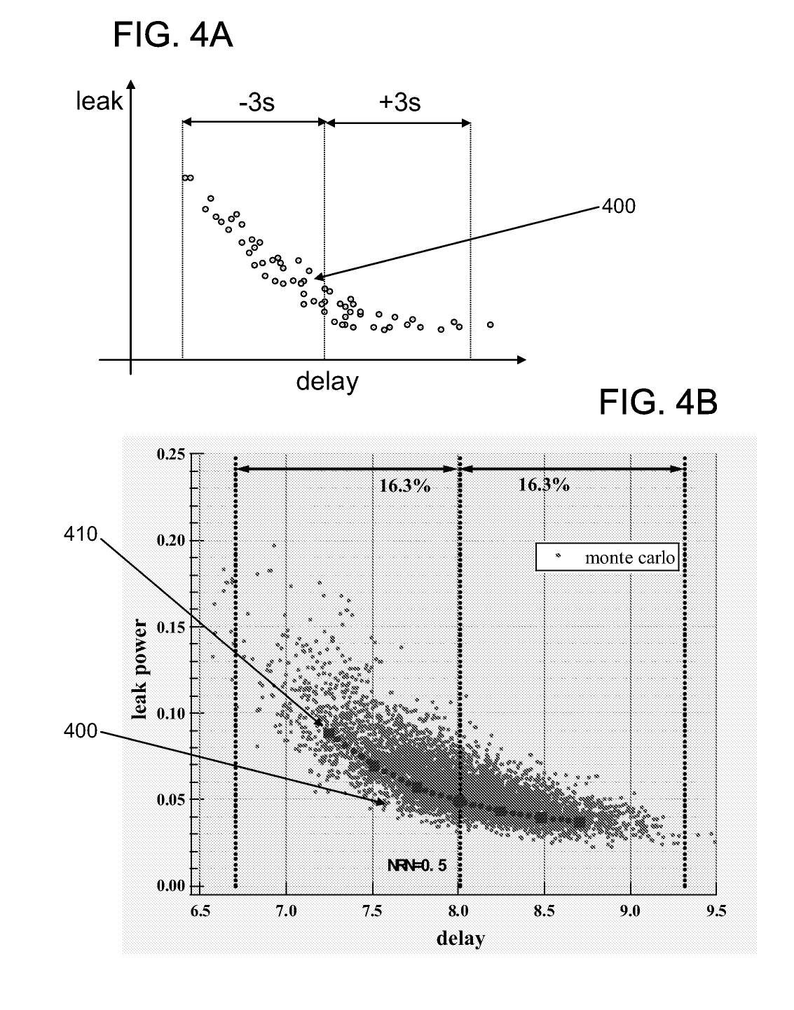

Referring to FIGS. 4A and 4B, leakage power is graphically depicted as a function of delay time. FIG. 4A is a representative graph of leakage power values charted against delay times, whereas FIG. 4B is an exemplary graph of leakage power values charted against delay times. The ranges of plus and minus three sigma from the mean were defined for the delay data and leakage power data to encompass most relevant events. As shown in FIGS. 4A and 4B, the distribution of leakage power data and the associated distribution of delay data form an overall performance distribution curve 400 that is relatively broad.

In light of the present invention and for illustration purposes, Lpoly values may be associated with delay values based only on the Lpoly values, so that leakage power may be expressed as a function of only Lpoly-based delays. In contrast to curve 400, the distribution of leakage power data and the associated distribution of Lpoly-based delay data form an Lpoly-based performance distribution curve 410 that is relatively narrow, as shown in FIG. 4B. The Lpoly-based performance distribution curve 410 is depicted as heavy dots in a chain, whereas the overall performance distribution curve 400 is depicted as small, scattered dots. The overall performance distribution curve 400 is much wider because it takes all delays of the test circuit 220 into account, and hence it provides a more accurate model than the narrow Lpoly-based performance distribution curve 410.

In accordance with one or more embodiments, the multi-processor system 100 may be implemented as a single-chip solution operable for stand-alone and/or distributed processing of media-rich applications, such as game systems, home terminals, PC systems, server systems and workstations. In some applications, such as game systems and home terminals, real-time computing may be a necessity. For example, in a real-time, distributed gaming application, one or more of networking image decompression, 3D computer graphics, audio generation, network communications, physical simulation, and artificial intelligence processes have to be executed quickly enough to provide the user with the illusion of a real-time experience. Thus, each processor in the multi-processor system 100 must complete tasks in a short and predictable time.

To this end, and in accordance with this computer architecture, all processors of a multi-processing computer system 100 are constructed from a common computing module (or cell). This common computing module has a consistent structure and preferably employs the same instruction set architecture. The multi-processing computer system 100 can be formed of one or more clients, servers, PCs, mobile computers, game machines, PDAs, set top boxes, appliances, digital televisions and other devices using computer processors.

A plurality of the computer systems 100 also may be members of a network if desired. The consistent modular structure enables efficient, high speed processing of applications and data by the multi-processing computer system, and if a network is employed, the rapid transmission of applications and data over the network. This structure also simplifies the building of members of the network of various sizes and processing power and the preparation of applications for processing by these members.

A description of a preferred computer architecture for a multi-processor system is provided in FIGS. 10-12 that is suitable for carrying out one or more of the features discussed herein.

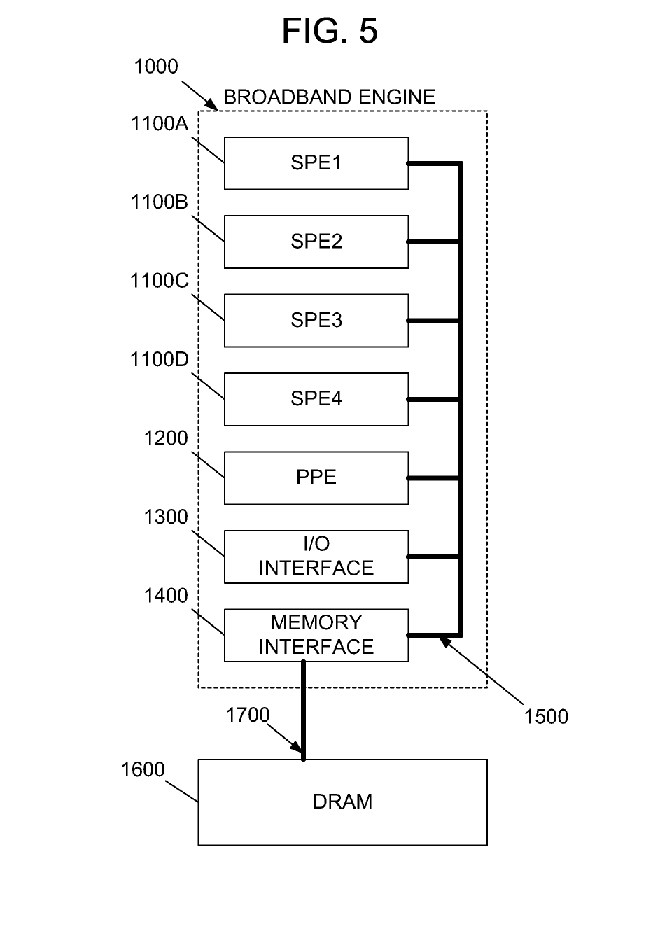

Referring to FIG. 5, a preferred structure of a basic processing module is shown as a broadband engine (BE) 1000 The BE 1000 comprises an I/O interface 1300, a POWER processing element (PPE) 1200, and a plurality of synergistic processing elements 1100, namely, synergistic processing element 1100A, synergistic processing element 1100B, synergistic processing element 1100C, and synergistic processing element 1100D. A local (or internal) BE bus 1500 transmits data and applications among the PPE 1200, the synergistic processing elements 1100, and a memory interface 1400. The local BE bus 1500 can have, e.g., a conventional architecture or can be implemented as a packet-switched network. If implemented as a packet switch network, while requiring more hardware, increases the available bandwidth.

The BE 1000 can be constructed using various methods for implementing digital logic. The BE 1000 preferably is constructed, however, as a single integrated circuit employing a complementary metal oxide semiconductor (CMOS) on a silicon substrate. Alternative materials for substrates include gallium arsinide, gallium aluminum arsinide and other so-called III-B compounds employing a wide variety of dopants. The BE 1000 also may be implemented using superconducting material, e.g., rapid single-flux-quantum (RSFQ) logic.

The BE 1000 is closely associated with a shared (main) memory 1600 through a high bandwidth memory connection 1700. Although the memory 1600 preferably is a dynamic random access memory (DRAM), the memory 1600 could be implemented using other means, e.g., as a static random access memory (SRAM), a magnetic random access memory (MRAM), an optical memory, a holographic memory, etc.

The PPE 1200 and the synergistic processing elements 1100 are preferably each coupled to a memory flow controller (MFC) including direct memory access DMA functionality, which in combination with the memory interface 1400, facilitate the transfer of data between the DRAM 1600 and the synergistic processing elements 1100 and the PPE 1200 of the BE 1000. It is noted that the DMAC and/or the memory interface 1400 may be integrally or separately disposed with respect to the synergistic processing elements 1100 and the PPE 1200. Indeed, the DMAC function and/or the memory interface 1400 function may be integral with one or more (preferably all) of the synergistic processing elements 1100 and the PPE 1200. It is also noted that the DRAM 1600 may be integrally or separately disposed with respect to the BE 1000. For example, the DRAM 1600 may be disposed off-chip as is implied by the illustration shown or the DRAM 1600 may be disposed on-chip in an integrated fashion.

The PPE 1200 can be, e.g., a standard processor capable of stand-alone processing of data and applications. In operation, the PPE 1200 preferably schedules and orchestrates the processing of data and applications by the synergistic processing elements. The synergistic processing elements preferably are single instruction, multiple data (SIMD) processors. Under the control of the PPE 1200, the synergistic processing elements perform the processing of these data and applications in a parallel and independent manner. The PPE 1200 is preferably implemented using a PowerPC core, which is a microprocessor architecture that employs reduced instruction-set computing (RISC) technique. RISC performs more complex instructions using combinations of simple instructions. Thus, the timing for the processor may be based on simpler and faster operations, enabling the microprocessor to perform more instructions for a given clock speed.

It is noted that the PPE 1200 may be implemented by one of the synergistic processing elements 1100 taking on the role of a main processing unit that schedules and orchestrates the processing of data and applications by the synergistic processing elements 1100. Further, there may be more than one PPE implemented within the broadband engine 1000.

In accordance with this modular structure, the number of BEs 1000 employed by a particular computer system is based upon the processing power required by that system. For example, a server may employ four BEs 1000, a workstation may employ two BEs 1000 and a PDA may employ one BE 1000. The number of synergistic processing elements 1100 of a BE 1000 assigned to processing a particular software cell depends upon the complexity and magnitude of the programs and data within the cell.

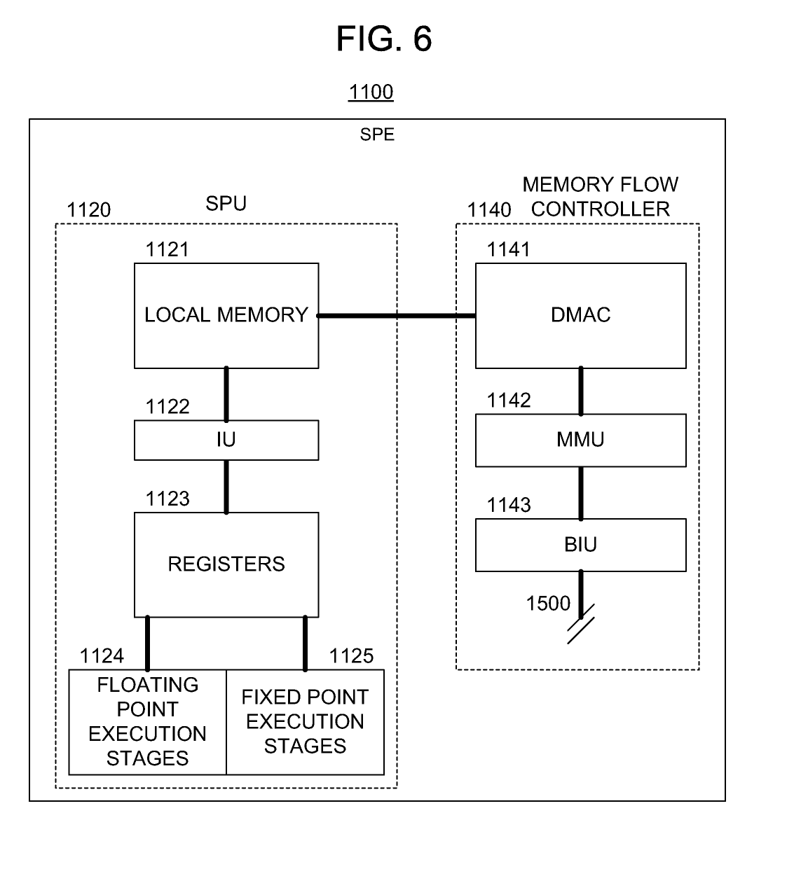

Referring to FIG. 6, a preferred structure of a synergistic processing element (SPE) 1100 is illustrated. The SPE 1100 architecture preferably fills a void between general-purpose processors (which are designed to achieve high average performance on a broad set of applications) and special-purpose processors (which are designed to achieve high performance on a single application). The SPE 1100 is designed to achieve high performance on game applications, media applications, broadband systems, etc., and to provide a high degree of control to programmers of real-time applications. Some capabilities of the SPE 1100 include graphics geometry pipelines, surface subdivision, Fast Fourier Transforms, image processing keywords, stream processing, MPEG encoding/decoding, encryption, decryption, device driver extensions, modeling, game physics, content creation, and audio synthesis and processing.

The synergistic processing element 1100 includes two basic functional units, namely a streaming processing unit (SPU) 1120 and a memory flow controller (MFC) 1140. The SPU 1120 performs program execution, data manipulation, etc., while the MFC 1140 performs functions related to data transfers between the SPU 1120 and the DRAM 1600 of the system.

The SPU 1120 includes a local memory 1121, an instruction unit (IU) 1122, registers 1123, one ore more floating point execution stages 1124 and one or more fixed point execution stages 1125. The local memory 1121 is preferably implemented using single-ported random access memory, such as an SRAM. Whereas most processors reduce latency to memory by employing caches, the SPU 1120 implements the relatively small local memory 1121 rather than a cache. Indeed, in order to provide consistent and predictable memory access latency for programmers of real-time applications (and other applications as mentioned herein) a cache memory architecture within the SPU 1120 is not preferred. The cache hit/miss characteristics of a cache memory results in volatile memory access times, varying from a few cycles to a few hundred cycles. Such volatility undercuts the access timing predictability that is desirable in, for example, real-time application programming. Latency hiding may be achieved in the local memory SRAM 1121 by overlapping DMA transfers with data computation. This provides a high degree of control for the programming of real-time applications. As the latency and instruction overhead associated with DMA transfers exceeds that of the latency of servicing a cache miss, the SRAM local memory approach achieves an advantage when the DMA transfer size is sufficiently large and is sufficiently predictable (e.g., a DMA command can be issued before data is needed).

A program running on a given one of the synergistic processing elements 1100 references the associated local memory 1121 using a local address. However, each location of the local memory 1121 is also assigned a real address (RA) within the memory map of the overall system. This allows Privilege Software to map a local memory 1121 into the Effective Address (EA) of a process to facilitate DMA transfers between one local memory 1121 and another local memory 1121. The PPE 1200 can also directly access the local memory 1121 using an effective address. In a preferred embodiment, the local memory 1121 contains 556 kilobytes of storage, and the capacity of registers 1123 is 128×128 bits.

The SPU 1120 is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the IU 1122 includes an instruction buffer, instruction decode circuitry, dependency check circuitry, and instruction issue circuitry.

The instruction buffer preferably includes a plurality of registers that are coupled to the local memory 1121 and operable to temporarily store instructions as they are fetched. The instruction buffer preferably operates such that all the instructions leave the registers as a group, i.e., substantially simultaneously. Although the instruction buffer may be of any size, it is preferred that it is of a size not larger than about two or three registers.

In general, the decode circuitry breaks down the instructions and generates logical micro-operations that perform the function of the corresponding instruction. For example, the logical micro-operations may specify arithmetic and logical operations, load and store operations to the local memory 1121, register source operands and/or immediate data operands. The decode circuitry may also indicate which resources the instruction uses, such as target register addresses, structural resources, function units and/or busses. The decode circuitry may also supply information indicating the instruction pipeline stages in which the resources are required. The instruction decode circuitry is preferably operable to substantially simultaneously decode a number of instructions equal to the number of registers of the instruction buffer.

The dependency check circuitry includes digital logic that performs testing to determine whether the operands of given instruction are dependent on the operands of other instructions in the pipeline. If so, then the given instruction should not be executed until such other operands are updated (e.g., by permitting the other instructions to complete execution). It is preferred that the dependency check circuitry determines dependencies of multiple instructions dispatched from the decode circuitry simultaneously.

The instruction issue circuitry is operable to issue the instructions to the floating point execution stages 1124 and/or the fixed point execution stages 1125.

The registers 1123 are preferably implemented as a relatively large unified register file, such as a 128-entry register file. This allows for deeply pipelined high-frequency implementations without requiring register renaming to avoid register starvation. Renaming hardware typically consumes a significant fraction of the area and power in a processing system. Consequently, advantageous operation may be achieved when latencies are covered by software loop unrolling or other interleaving techniques.

Preferably, the SPU 1120 is of a superscalar architecture, such that more than one instruction is issued per clock cycle. The SPU 1120 preferably operates as a superscalar to a degree corresponding to the number of simultaneous instruction dispatches from the instruction buffer, such as between 2 and 3 (meaning that two or three instructions are issued each clock cycle). Depending upon the required processing power, a greater or lesser number of floating point execution stages 1124 and fixed point execution stages 1125 may be employed. In a preferred embodiment, the floating point execution stages 1124 operate at a speed of 32 billion floating point operations per second (32 GFLOPS), and the fixed point execution stages 1125 operate at a speed of 32 billion operations per second (32 GOPS).

The MFC 1140 preferably includes a direct memory access controller (DMAC) 1141, a memory management unit (MMU) 1142, and a bus interface unit (BIU) 1143. With the exception of the DMAC 1141, the MFC 1140 preferably runs at half frequency (half speed) as compared with the SPU 1120 and the bus 1500 to meet low power dissipation design objectives. The MFC 1140 is operable to handle data and instructions coming into the SPE 1100 from the bus 1500, provides address translation for the DMAC, and snoop-operations for data coherency. The BIU 1143 provides an interface between the bus 1500 and the MMU 1142 and DMAC 1141. Thus, the SPE 1100 (including the SPU 1120 and the MFC 1140) and the DMAC 1141 are connected physically and/or logically to the bus 1500.

The MMU 1142 is preferably operable to translate effective addresses (taken from DMA commands) into real addresses for memory access. For example, the MMU 1142 may translate the higher order bits of the effective address into real address bits. The lower-order address bits, however, are preferably untranslatable and are considered both logical and physical for use to form the real address and request access to memory. In one or more embodiments, the MMU 1142 may be implemented based on a 64-bit memory management model, and may provide 2⁶⁴ bytes of effective address space with 4K−, 64K−, 1M−, and 16M− byte page sizes and 256 MB segment sizes. Preferably, the MMU 1142 is operable to support up to 2⁶⁵ bytes of virtual memory, and 2⁴² bytes (4 TeraBytes) of physical memory for DMA commands. The hardware of the MMU 1142 may include an 8-entry, fully associative SLB, a 256-entry, 4 way set associative TLB, and a 4×4 Replacement Management Table (RMT) for the TLB—used for hardware TLB miss handling.

The DMAC 1141 is preferably operable to manage DMA commands from the SPU 1120 and one or more other devices such as the PPE 1200 and/or the other SPUs. There may be three categories of DMA commands: Put commands, which operate to move data from the local memory 1121 to the shared memory 1600; Get commands, which operate to move data into the local memory 1121 from the shared memory 1600; and Storage Control commands, which include SLI commands and synchronization commands. The synchronization commands may include atomic commands, send signal commands, and dedicated barrier commands. In response to DMA commands, the MMU 1142 translates the effective address into a real address and the real address is forwarded to the BIU 1143.

The SPU 1120 preferably uses a channel interface and data interface to communicate (send DMA commands, status, etc.) with an interface within the DMAC 1141. The SPU 1120 dispatches DMA commands through the channel interface to a DMA queue in the DMAC 1141. Once a DMA command is in the DMA queue, it is handled by issue and completion logic within the DMAC 1141. When all bus transactions for a DMA command are finished, a completion signal is sent back to the SPU 1120 over the channel interface.

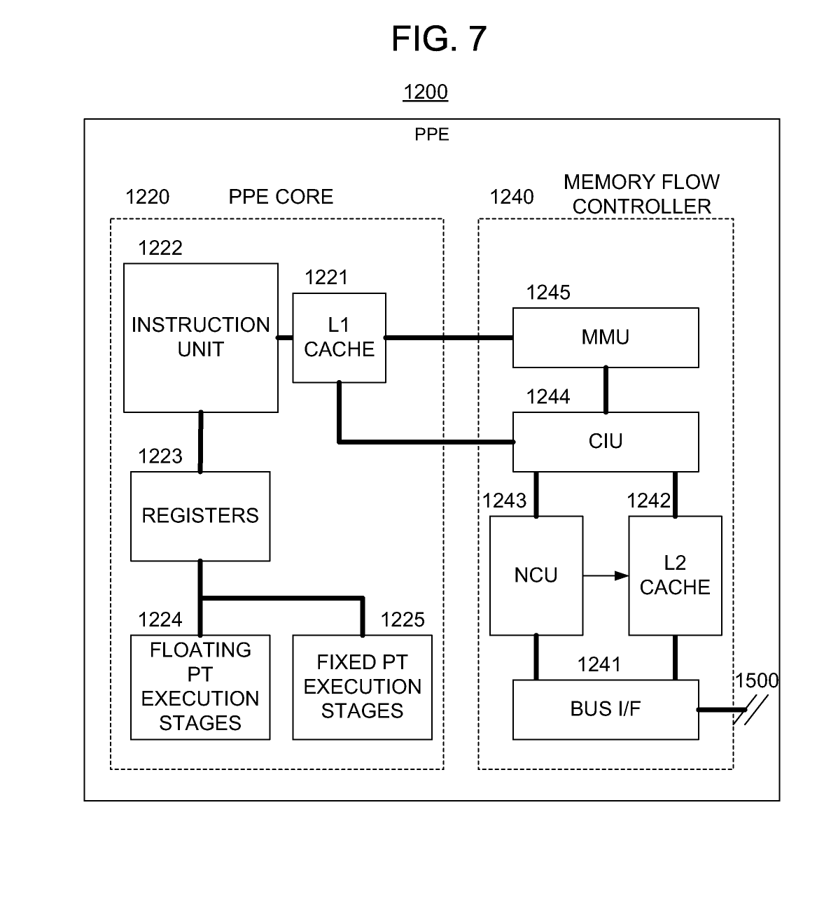

Referring to FIG. 7, a preferred structure of the PPE 1200 is illustrated. The PPE 1200 includes two basic functional units, the PPE core 1220 and the memory flow controller (MFC) 1240. The PPE core 1220 performs program execution, data manipulation, multi-processor management functions, etc., while the MFC 1240 performs functions related to data transfers between the PPE core 1220 and the memory space of the system 100.

The PPE core 1220 may include an L1 cache 1221, an instruction unit 1222, registers 1223, one or more floating point execution stages 1224 and one or more fixed point execution stages 1225. The L1 cache 1221 provides data caching functionality for data received from the shared memory 1600, the processors 1100, or other portions of the memory space through the MFC 1240. As the PPE core 1220 is preferably implemented as a superpipeline, the instruction unit 1222 is preferably implemented as an instruction pipeline with many stages, including fetching, decoding, dependency checking, issuing, etc. The PPE core 1220 is also preferably of a superscalar configuration, whereby more than one instruction is issued from the instruction unit 1222 per clock cycle. To achieve a high processing power, the floating point execution stages 1224 and the fixed point execution stages 1225 include a plurality of stages in a pipeline configuration. Depending upon the required processing power, a greater or lesser number of floating point execution stages 1224 and fixed point execution stages 1225 may be employed.

The MFC 1240 includes a bus interface unit (BIU) 1241, an L2 cache memory 1242, a non-cachable unit (NCU) 1243, a core interface unit (CIU) 1244, and a memory management unit (MMU) 1245. Most of the MFC 1240 runs at half frequency (half speed) as compared with the PPE core 1220 and the bus 1500 to meet low power dissipation design objectives.

The BIU 1241 provides an interface between the bus 1500 and the L2 cache 1242 and NCU 1243 logic blocks. To this end, the BIU 1241 may act as a Master as well as a Slave device on the bus 1500 in order to perform fully coherent memory operations. As a Master device it may source load/store requests to the bus 1500 for service on behalf of the L2 cache 1242 and the NCU 1243. The BIU 1241 may also implement a flow control mechanism for commands which limits the total number of commands that can be sent to the bus 1500. The data operations on the bus 1500 may be designed to take eight beats and, therefore, the BIU 1241 is preferably designed around 128 byte cache-lines and the coherency and synchronization granularity is 128 KB.

The L2 cache memory 1242 (with supporting hardware logic) is preferably designed to cache 512 KB of data. For example, the L2 cache 1242 may handle cacheable loads/stores, data pre-fetches, instruction fetches, instruction pre-fetches, cache operations, and barrier operations. The L2 cache 1242 is preferably an 8-way set associative system. The L2 cache 1242 may include six reload queues matching six (6) castout queues (e.g., six RC machines), and eight (64-byte wide) store queues. The L2 cache 1242 may operate to provide a backup copy of some or all of the data in the L1 cache 1221. Advantageously, this is useful in restoring state(s) when processing nodes are hot-swapped. This configuration also permits the L1 cache 1221 to operate more quickly with fewer ports, and permits faster cache-to-cache transfers (because the requests may stop at the L2 cache 1242). This configuration also provides a mechanism for passing cache coherency management to the L2 cache memory 1242.

The NCU 1243 interfaces with the CIU 1244, the L2 cache memory 1242, and the BIU 1241 and generally functions as a queuing/buffering circuit for non-cacheable operations between the PPE core 1220 and the memory system. The NCU 1243 preferably handles all communications with the PPE core 1220 that are not handled by the L2 cache 1242, such as cache-inhibited load/stores, barrier operations, and cache coherency operations. The NCU 1243 is preferably run at half speed to meet the aforementioned power dissipation objectives.

The CIU 1244 is disposed on the boundary of the MFC 1240 and the PPE core 1220 and acts as a routing, arbitration, and flow control point for requests coming from the execution stages 1224, 1225, the instruction unit 1222, and the MMU unit 1245 and going to the L2 cache 1242 and the NCU 1243. The PPE core 1220 and the MMU 1245 preferably run at full speed, while the L2 cache 1242 and the NCU 1243 are operable for a 2:1 speed ratio. Thus, a frequency boundary exists in the CIU 1244 and one of its functions is to properly handle the frequency crossing as it forwards requests and reloads data between the two frequency domains.

The CIU 1244 is comprised of three functional blocks: a load unit, a store unit, and reload unit. In addition, a data pre-fetch function is performed by the CIU 1244 and is preferably a functional part of the load unit. The CIU 1244 is preferably operable to: (i) accept load and store requests from the PPE core 1220 and the MMU 1245; (ii) convert the requests from full speed clock frequency to half speed (a 2:1 clock frequency conversion); (iii) route cachable requests to the L2 cache 1242, and route non-cachable requests to the NCU 1243; (iv) arbitrate fairly between the requests to the L2 cache 1242 and the NCU 1243; (v) provide flow control over the dispatch to the L2 cache 1242 and the NCU 1243 so that the requests are received in a target window and overflow is avoided; (vi) accept load return data and route it to the execution stages 1224, 1225, the instruction unit 1222, or the MMU 1245; (vii) pass snoop requests to the execution stages 1224, 1225, the instruction unit 1222, or the MMU 1245; and (viii) convert load return data and snoop traffic from half speed to full speed.

The MMU 1245 preferably provides address translation for the PPE core 440A, such as by way of a second level address translation facility. A first level of translation is preferably provided in the PPE core 1220 by separate instruction and data ERAT (effective to real address translation) arrays that may be much smaller and faster than the MMU 1245.

In a preferred embodiment, the PPE 1200 operates at 4-6 GHz, 10F04, with a 64-bit implementation. The registers are preferably 64 bits long (although one or more special purpose registers may be smaller) and effective addresses are 64 bits long. The instruction unit 1222, registers 1223 and execution stages 1224 and 1225 are preferably implemented using PowerPC technology to achieve the (RISC) computing technique.

Additional details regarding the modular structure of this computer system may be found in U.S. Pat. No. 6,526,491, the entire disclosure of which is hereby incorporated by reference.

In accordance with at least one further aspect of the present invention, the methods and apparatus described above may be achieved utilizing suitable hardware, such as that illustrated in the figures. Such hardware may be implemented utilizing any of the known technologies, such as standard digital circuitry, any of the known processors that are operable to execute software and/or firmware programs, one or more programmable digital devices or systems, such as programmable read only memories (PROMs), programmable array logic devices (PALs), etc. Furthermore, although the apparatus illustrated in the figures are shown as being partitioned into certain functional blocks, such blocks may be implemented by way of separate circuitry and/or combined into one or more functional units. Still further, the various aspects of the invention may be implemented by way of software and/or firmware program(s) that may be stored on suitable storage medium or media (such as floppy disk(s), memory chip(s), etc.) for transportability and/or distribution.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of estimating leakage power of a test circuit, the method comprising:
deriving a leakage power estimation as a function of a delay data distribution.

2. The method of claim 1, further comprising:
utilizing the test circuit; and
measuring leakage power and delay for a utilization of the test circuit.

3. The method of claim 2, further comprising:
obtaining for the utilization a statistical sampling of a leakage power data distribution and of the delay data distribution; and
correlating the leakage power data distribution and the delay data distribution.

4. The method of claim 3, wherein:
the utilization comprises a simulation based on a schematic design of the test circuit.

5. The method of claim 4, further comprising:
creating the schematic design of the test circuit; and
incorporating a delay chain into the schematic design to obtain the delay data distribution.

6. The method of claim 4, wherein the test circuit comprises a proposed circuit.

7. The method of claim 4, wherein the schematic design comprises defined poly gate lengths, on-chip devices, and power sources.

8. A leakage power estimation tool comprising:
a leakage power measurement device;
a delay time measurement device; and
a processing system
wherein the processing system is operable to correlate:
leakage power data of a utilization a test circuit, obtained from the leakage power measurement device, and
delay time data of the utilization the test circuit, obtained from the delay time measurement device,
to derive an equation with which the processing system is operable to estimate leakage power as a function of delay time.

9. The leakage power estimation tool of claim 8, wherein:
the leakage power data comprise a statistical sampling of a distribution of leakage power measurements of the utilization the test circuit, and
the delay time data comprise a statistical sampling of a distribution of delay time measurements of the utilization the test circuit.

10. The leakage power estimation tool of claim 9, wherein:
the utilization the test circuit comprises performance of various test operations.

11. The leakage power estimation tool of claim 8, wherein:
the leakage power measurement device comprises a first software component; and
the delay time measurement device comprises a second software component.

12. The leakage power estimation tool of claim 11, wherein:
the first and second software components are executable on the processing system.

13. The leakage power estimation tool of claim 12, wherein:
the utilization of the test circuit is a simulation based on a schematic design of the test circuit.

14. The leakage power estimation tool of claim 13, wherein:
the schematic design comprises a delay chain, defined poly gate lengths, on-chip devices, and power sources.

15. The leakage power estimation tool of claim 13, wherein:
the test circuit comprises a proposed circuit.

16. A computer-readable storage medium containing computer-executable instructions capable of causing a processing system to perform actions of a method of estimating leakage power of a test circuit, the actions comprising:
deriving a leakage power estimation as a function of delay distribution.

17. The computer-readable storage medium of claim 16, the actions further comprising:
utilizing the test circuit; and
measuring leakage power and delay for a utilization of the test circuit.

18. The computer-readable storage medium of claim 17, the actions further comprising:
obtaining for the utilization a statistical sampling of a leakage power data distribution and of the delay data distribution; and
correlating the leakage power data distribution and the delay data distribution.

19. The computer-readable storage medium of claim 18, wherein:
the utilization comprises a simulation based on a schematic design of the test circuit.

20. The computer-readable storage medium of claim 19, the actions further comprising:
creating the schematic design of the test circuit; and
incorporating a delay chain into the schematic design to obtain the delay data distribution.

21. The computer-readable storage medium of claim 19, wherein the test circuit comprises a proposed circuit.

22. The computer-readable storage medium of claim 19, wherein the schematic design comprises defined poly gate lengths, on-chip devices, and power sources. chip
